(19) United States
(12) Patent Application Publication
(10) Pub. No.: US 2015/0314753 A1
(43) Pub. Date: Nov. 5, 2015

(54) PORTABLE, SELF-CONTAINED ANTI-THEFT ALARM SYSTEM FOR THE CARGO COMPARTMENT OF A VEHICLE

(71) Applicant: BABACO ALARM SYSTEMS, INC., Moonachie, NJ (US)

(72) Inventor: Greg Haber, Woodbury, NY (US)

(21) Appl. No.: 14/700,913

(22) Filed: Apr. 30, 2015

Related U.S. Application Data
(60) Provisional application No. 61/986,963, filed on May 1, 2014.

(51) Int. Cl. B60R 25/10

(52) U.S. Cl. CPC B60R 25/1004; B60R 25/1018; B60R 25/1003

(57) ABSTRACT

The components of the alarm system are fully enclosed within a portable housing and require no external power or data signal connections. An audible signal is generated by a siren in response to a trigger signal from a light sensor, indicating the opening of the cargo compartment access door, a motion sensor detecting movement, or a tilt sensor indicating the housing being moved. The components include a CPU for generating an alarm signal when a trigger signal is received from one or more of the sensors. A GPS unit transmits a signal indicating the alarm has been triggered and the location of the housing in response to the alarm signal. An internal power source in the form of rechargeable batteries is provided. The system can be controlled by switches located on the housing or remotely by buttons on a hand-held transmitter.

### BACKGROUND OF THE INVENTION

1. Field of the Invention

The present invention relates to anti-theft alarm systems for protecting cargo stored or transported in vehicle cargo compartments, and more particularly to a portable and entirely self-contained anti-theft alarm system for protecting vehicle cargo designed for use on vehicles which do not have permanently installed anti-theft alarm systems.

2. Description of Prior Art Including Information Disclosed Under 37 CFR 1.97 and 1.98

Anti-theft alarm systems designed to be permanently installed on vehicles with closed compartments in which cargo is stored and/or transported are well-known in the art. Such systems include electronic components situated within housings physically attached to structural members of a vehicle and hard wired to the electrical system of the vehicle for power. Such systems are commonly connected to magnetic sensors or sensors with spring-loaded depressible parts mounted in door jams associated with the access doors to the cargo compartment. The alarm system may also be hard wired to the ignition system of the vehicle to prevent the engine of the vehicle from being started upon detecting unauthorized entry to the cargo compartment or other door of the vehicle.

Currently, the only portable security devices available on the market to protect vehicle cargo are padlocks. However, padlocks can be circumvented relatively easily and do not provide the level of security required by commercial cargo storage and transport vehicles.

Permanently installed anti-theft alarm systems tend to be less vulnerable to attack but are not suitable for all purposes. Shippers that do not have a dedicated fleet of cargo transport vehicles need to be able to secure the cargo stored and transported in vehicles which are sometimes used to perform other tasks. Moreover, shippers may at times employ third party carriers which do not have installed anti-theft systems or have installed anti-theft systems which are not sufficiently robust to adequately protect the cargo being stored or transported.

It is therefore, a prime object of the present invention to provide a portable, self-contained anti-theft alarm system which can be placed in and relocated to any vehicle with an enclosed cargo compartment.

It is another object of the present invention to provide a portable, self-contained anti-theft alarm system for the cargo compartment of a vehicle which has internal sensors and power supply and does not require any external power or data connections.

It is another object of the present invention to provide a portable, self-contained anti-theft alarm system for the cargo compartment of a vehicle which can detect the opening of a cargo access door without the necessity of permanently installed sensors.

It is another object of the present invention to provide a portable, self-contained anti-theft alarm system for the cargo compartment of a vehicle which monitors the light in the compartment in which it is located and sounds an alarm when the light in the compartment exceeds a given threshold level, indicating that the cargo access door has been opened.

It is another object of the present invention to provide a portable, self-contained anti-theft alarm system for the cargo compartment of a vehicle which monitors movement in the vicinity of the alarm housing and sounds an alarm when motion is detected.

It is another object of the present invention to provide a portable, self-contained anti-theft alarm system for the cargo compartment of a vehicle which monitors the position of the alarm housing and sounds an alarm when the housing is tilted beyond a given threshold level, indicating that the alarm is being moved.

It is another object of the present invention to provide a portable, self-contained anti-theft alarm system for the cargo compartment of a vehicle which includes a GPS unit with a transmitter capable of transmitting a signal indicating the triggered state of the alarm as well as the location of the alarm upon detecting a security breach.

It is another object of the present invention to provide a portable, self-contained anti-theft alarm system for the cargo compartment of a vehicle which automatically arms upon energizing the light and tilt sensors.

It is another object of the present invention to provide a portable, self-contained anti-theft alarm system for the cargo compartment of a vehicle which can be controlled remotely.

### BRIEF SUMMARY OF THE INVENTION

In general, the above objects are achieved by the present invention which is a portable, self-contained anti-theft alarm system designed for use in the cargo compartment of a vehicle of the type having an access door. The alarm system includes a housing adapted to be situated within the cargo compartment which fully encloses an interior space within which the electrical components of the alarm system are situated. The components create an audible signal in response to the opening of the cargo compartment access door or the tilting of the alarm system housing.

The alarm system components include a central processing unit (CPU) capable of generating an alarm signal output upon the detection of a security breach by any of three types of sensors. The output of a first sensor is connected to a CPU input and provides a first trigger signal to the CPU upon detection of light exceeding a given threshold level in the vicinity of the housing, indicating that the access door to the cargo compartment has been opened. The output of the second sensor is connected to another CPU input and provides a second trigger signal to the CPU upon detection of motion in the vicinity of the alarm. The output of a third sensor detects the tilting of the alarm housing and provides a third trigger signal to the CPU upon detection of tilting of the housing exceeding a given threshold level. The CPU generates the alarm signal output in response to receiving either the first trigger signal or the second trigger signal.

A sound generator in the form of a siren or speaker is connected to a CPU output and generates the audible signal in response to the alarm signal output.

The alarm components also include a GPS unit connected to a CPU output. The GPS unit is capable of wirelessly transmitting a transmit signal in response to the alarm signal output, indicating the triggered state of the alarm and the location of the housing.

A power source situated within the housing is connected to energize the electronic alarm system components. A master power switch connects the power source to the alarm system components.

The alarm system also includes a hand-held transmitter for remotely controlling the state of the alarm system.

The alarm has a key activated disarm switch accessible of the exterior of the housing for arming and disarming the alarm system.

The internal power source preferably consists of one or more batteries. The batteries are preferably rechargeable. The alarm system includes a circuit for recharging the batteries when the alarm system is not in use.

The alarm system housing is a metal box formed of four side walls, a top wall and a bottom wall.

The alarm system housing also has one or more handles for facilitating manual transport of the alarm system from one vehicle cargo compartment to another.

The alarm system housing has a wall proximate the audio signal generator. One or more vents in the housing wall are provided such that sound can travel from the audible signal generator the interior of the housing can exit the housing.

The alarm system is armed in response to energizing the light and tilt sensors.

The alarm has an externally accessible, key actuated disarm switch. The alarm is armed in response to the sensors being turned on, if the externally accessible key actuated switch is in the “arm” position. The alarm is automatically re-armed in response to energizing the sensors, as long as the externally accessible key actuated switch is in the “arm” position.

### BRIEF DESCRIPTION OF THE SEVERAL VIEWS OF DRAWINGS

To these and to such other objects that may hereinafter appears, the present invention relates to a portable, self-contained anti-theft alarm system for the cargo compartment of a vehicle as described in detail in the following specification and recited in the annexed claims, taken together with the accompanying drawings, in which like numerals refer to like parts and in which:

FIG. 1 is a front elevation view of the housing of the present invention showing the sensors and switches;

FIG. 2 is a side view of the housing of the present invention;

FIG. 3 is a block diagram of the electronic components of the present invention; and

FIG. 4 is a flow chart of the operation of the present invention.

### DETAILED DESCRIPTION OF THE INVENTION

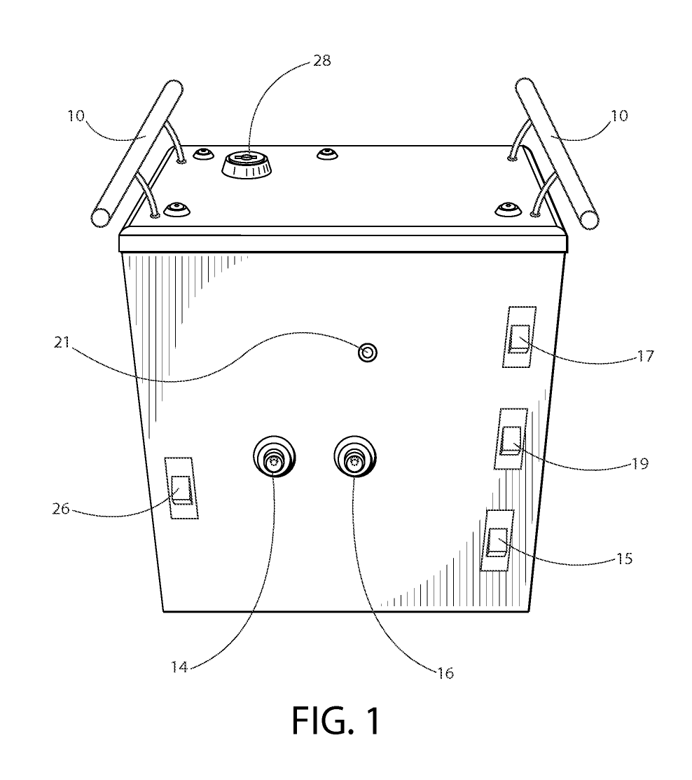

The electronic components of the alarm system of the present invention are situated entirely within a metal box-like housing, generally designated A, as illustrated in FIG. 1. Housing A includes four side walls, a top wall and a bottom wall so as to fully enclose all of the electronic components of the alarm system. The housing is designed to be portable and easily moveable from one location to another. No external power or data connections are required for the alarm system to operate.

Several handles 10 are attached to and extend from the exterior of the housing. The handles are provided to facilitate manual transport of the alarm system between locations.

To make the alarm system portable, all of the electronic components are situated entirely within housing A. The alarm system is self-contained because it does not require any wire connections to external power sources or data signal input from external sensors during operation. The alarm system also does not require any wire connection to an external sound generator or a communications device. The only external connection employed is to an A.C. power source used to recharge the internal batteries between uses of the alarm system, when necessary, as explained below.

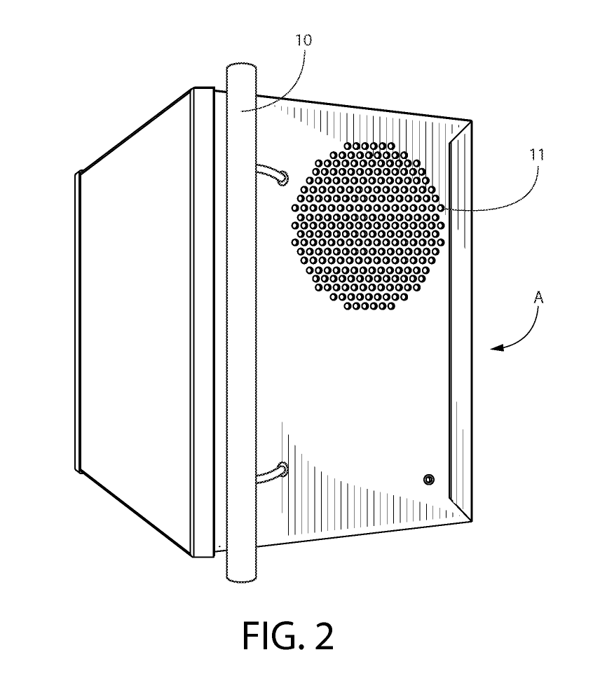

As illustrated in FIG. 1, the various switches which control the functions of the components can be accessed from the exterior of the housing. As illustrated in FIG. 2, on housing side wall has a pattern of vent openings 11 situated proximate an internally mounted siren or speaker component 12 such that the sound generated by the component can exit the housing without substantial degradation.

FIG. 1 shows two openings formed in the housing side wall in alignment with the light sensor 14 and motion sensor 16, respectively. The openings are provided such that the light sensor 14 can detect changes in the light level within the vicinity of the alarm system housing and motion sensor 16 can detect motion within the vicinity of the alarm system housing or motion of the vehicle.

A tilt sensor 18 is also situated within the housing. Sensor 18 will detect the tilting of the alarm system housing if there is an attempt to move the housing or remove the housing from the cargo compartment in which the alarm system is located. Tilt sensor 18 does not require an opening in the housing side wall to function.

Toggle switches for turning each of the sensors 14, 16 and 18 on and off are accessible from the exterior of housing A and located on the side wall of the housing. Switch 15 controls the operation of light sensor 14. Switch 17 controls the function of motion sensor 16. Switch 19 controls the function of sensor 18.

The alarm system is designed to protect cargo in an enclosed vehicle compartment having an access door. Once situated within the cargo compartment and armed, the alarm system can generate an audible signal and/or wirelessly transmit a signal indicating that the alarm system has been triggered and the location of the housing when the alarm is triggered, upon the detection of unauthorized opening of the vehicle cargo compartment access door, movement in the vicinity of the housing, tilting of the housing or movement of the vehicle in which the alarm system is located.

The alarm system requires no connections to external sensors to function as all of the necessary sensors are contained within housing A. Accordingly, the alarm system is designed to be easily moved and relocated from the cargo compartment of one vehicle to the cargo compartment of another vehicle, as needed.

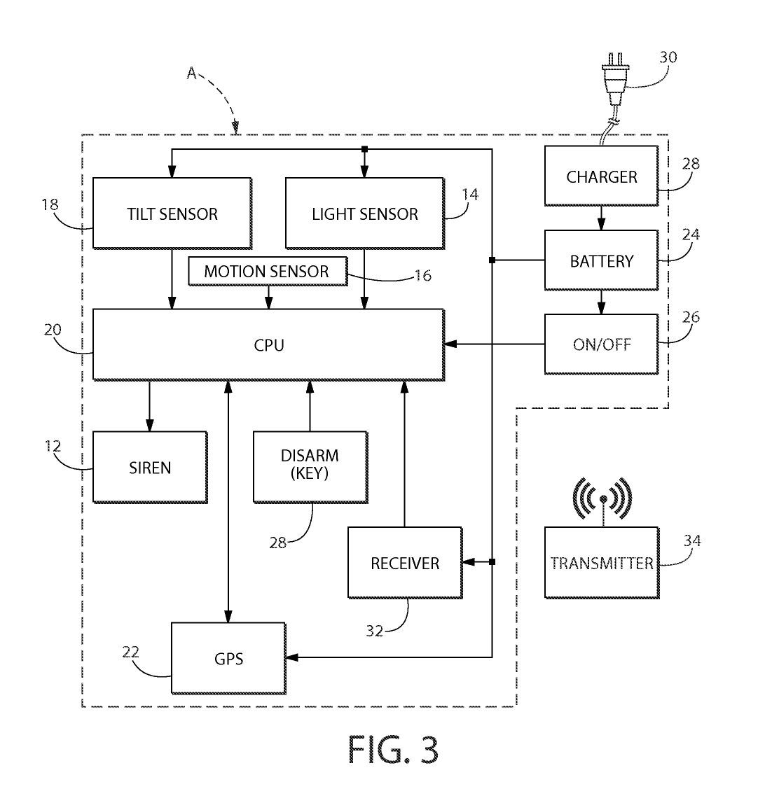

As illustrated in the block diagram of FIG. 3, the components of the alarm system located within housing A include a central processing unit (CPU) 20 which controls all of the functions of the system. The CPU is capable of generating an alarm signal output in response to a trigger signal output from light sensor 14, motion sensor 16 or tilt sensor 18.

CPU 20 can be a PIC16F1784 28 pin 8-bit Advanced Analog Flash MCU of Chandler, Az. or the equivalent thereof.

The output of light sensor 14 is connected to one of the CPU inputs. Sensor 14 provides a first trigger signal to the CPU upon detecting light exceeding a given threshold level within the cargo compartment in which the housing is situated, indicating that the door to the cargo compartment has been opened.

Light sensor 14 may be any commercially available light sensor with sufficient sensitivity. A sensor that works acceptanly in this alarm system is available from Sure Action Inc. of Hampton Bays, N.Y.

The output of motion sensor 16 is connected to another of the CPU inputs. Sensor 16 provides a second trigger signal to the CPU upon detecting motion in the vicinity of the alarm system housing or movement of the vehicle in which the alarm system housing is located.

Motion sensor 16 can be a SPY1 wired detector available from Visonic Ltd. of Tel Aviv, Israel.

The output of a tilt sensor 18 is connected to a third CPU input. Sensor 18 provides a third trigger signal to the CPU upon detecting the tilting of the housing exceeding a given threshold level, indicating that the housing is being moved.

Tilt sensor 18 may take the form of Part #20144 from International Sensor Controls, Inc. of Sandy Hook, Conn. or an equivalent product.

As noted previously, internal sensors 14, 16 and 18 are controlled by externally accessible toggle switches 15, 17 and 19, respectively. However, switches 15, 17 and 19 are not illustrated in FIG. 3.

When the system is armed, CPU 20 generates an alarm signal in response to either the first trigger signal from light sensor 14, the second trigger signal from the motion sensor 16, or the third trigger signal from the tilt sensor 18. A sound generator 12 in the form of a siren or speaker is connected to an output of the CPU. Siren/speaker 12 generates an audible signal in response to the alarm signal output of the CPU. The audible signal from the sound generator is loud enough to be heard at considerable distance.

A pilot light 21 is located on the side wall of housing A. The pilot light allows one to observe the housing and determine if the power of the alarm system is on.

A GPS unit 22, including a wireless transmitter, is also situated within housing A. The GPS unit is connected to receive the alarm signal output of the CPU. Unit 22 is capable creating and wireles sly transmitting a transmit signal in response to the alarm signal output. The transmit signal indicates the triggered state of the alarm and the location of the housing when the triggered state occurs.

Also included within housing 10 is a power source 24 connected to energize the alarm system components. Power source 24 is connected to the alarm system components through a master power switch 26. Switch 26 is accessible from the exterior of the housing.

A key activated “Disarm” switch 28 is connected to the CPU and is also accessible from the exterior of the housing. Switch 28 is provided to arm and disarm the alarm system and requires a key to do so.

Preferably, power source 24 includes one or more rechargeable batteries. A charging circuit 28 is provided within housing A. Circuit 28 is connected to the batteries which form power source 24 and to an external plug 30. Plug 30 can be inserted into any standard 120 v A.C. wall outlet to recharge the batteries between uses of the alarm system.

Also included within housing A is a wireless receiver 32. The output of receiver 32 is connected to an input of the CPU. Receiver 32 is wirelessly connected to a hand-held transmitter 34, which may take the form of a key fob, and preferably has 16 bit RF encryption so that it provides a secure means of controlling the alarm system remotely. By manipulating pushbuttons on transmitter 34, the alarm system can be remotely controlled to arm and disarm the system or to silence an audible alarm.

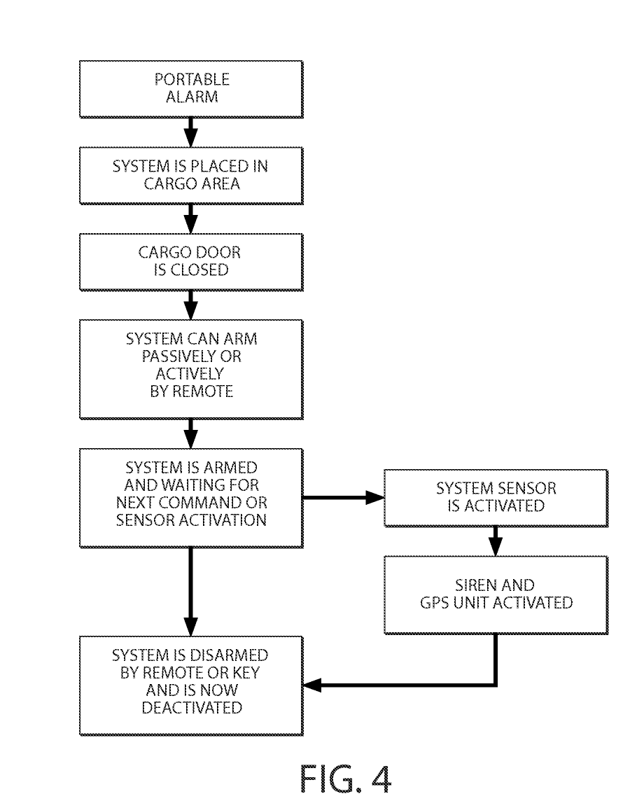

In use, as illustrated in FIG. 4, the alarm system is situated within the enclosed cargo compartment of a vehicle of the type having an access door. Preferably, the alarm system housing is placed in the vicinity of the access door such that the internal light sensor can detect changes in light level in the vicinity of the housing resulting from the opening of the access door. Before arming the system, the access door is closed.

With the “Disarm” switch 28 in the “arm” position, the sensors 14, 16 and 18 are each turned “on” by toggle switches 15, 17 and 19, respectively, which are accessible from the housing exterior. The master power switch 26, also accessible from the exterior of the housing, is then turned “on.” The system “beeps” once indicating that it is armed. If the alarm system continues “beeping” that indicates that it there is too much light in the vicinity of the housing for the light sensor to activate and that the housing should be relocated to a position within the cargo compartment where there is less light so the alarm system can be successfully armed. Alternatively, the system can be armed remotely using the hand-held transmitter 32. Thus, the system is automatically armed in response to the sensors being turned “on”, if the power is on and the externally accessible “Disarm” switch is in the “arm” position.

Once armed, if the light sensor 14 detects light exceeding a pre-set threshold level, the motion sensor detects motion, or the tilt sensor detects that the housing is tilted beyond a pre-set threshold level, the CPU will generate the alarm signal output to siren/speaker 12 which will broadcast a very loud sound, and to the GPS unit 22, which will wirelessly transmit a signal to a remote location, such as a monitoring station, indicating the state of the alarm (“triggered”) and the location of the vehicle in which the alarm system is situated.

The alarm can be silenced by depressing the appropriate button on the hand-held transmitter 34 or by setting the “Disarm” switch 28 to the “disarm” position. The alarm will automatically re-arm once the “Disarm” switch is moved to the “arm” position and the sensors clear and activate.

To relocate the alarm system, either to a place where the batteries can be recharged or to another vehicle cargo compartment, the sensors are each turned “off” or the “Disarm” switch is moved to the “disarm” position or power is turned off through the master power switch.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

I claim:

1. A portable, self-contained anti-theft alarm system for use in the cargo compartment of a vehicle of the type having an access door, the alarm comprising a housing adapted to be situated within the vehicle cargo compartment and enclose the alarm system components, said alarm system components comprising a central processing unit (CPU) capable of generating an alarm signal, an internal sensor connected to said CPU for providing a trigger signal to said CPU upon detecting light exceeding a given level outside said housing, and internal motion sensor connected to said CPU for providing a trigger signal to said CPU indicating that motion has been sensed, a internal sensor connected to said CPU for providing a trigger signal to said CPU upon detecting the tilting of said housing, said CPU generating said alarm signal in response to at least one of said trigger signals, a sound generator connected to said CPU for generating an audible signal in response to said alarm signal, and an internal power source connected to energize said components.

2. The alarm system of claim 1 wherein said components further comprise a GPS unit connected to said CPU and capable of wirelessly transmitting a transmit signal in response to said alarm signal indicating the triggered state of the alarm system and the location of the housing.

3. The alarm system of claim 1 further comprising a master power switch connecting said power source to said components.

4. The alarm system of claim 3 further comprising a hand-held transmitter for remotely controlling alarm operation.

5. The alarm system of claim 1 further comprising a key activated switch accessible of the exterior of said housing for arming and disarming the alarm system.

6. The alarm system of claim 1 wherein said power source is a battery.

7. The alarm system of claim 6 wherein said battery is rechargeable.

8. The alarm system of claim 7 further comprising an internal recharging circuit for said battery.

9. The alarm system of claim 1 wherein said housing is a metal box comprising four side walls, a top wall and a bottom wall.

10. The alarm system of claim 1 wherein said housing comprises a handle for facilitating transport of the housing.

11. The alarm system of claim 1 wherein said housing comprises a wall proximate said audible signal generator and one or more vent openings in said housing wall such that sound can travel from the interior of the housing to the exterior of the housing.

12. The alarm system of claim 1 wherein the alarm is armed in response to energizing said sensors.

13. The alarm system of claim 1 further comprising an externally accessible, key actuated “Disarm” switch.

14. The alarm system of claim 13 wherein the alarm system is armed in response to the sensors being turned on, if said key actuated Disarm switch is in the “arm” position.

15. The alarm system of claim 1 wherein the alarm is automatically re-armed in response to turning on said sensors, after said sensors have been de-energized.
